(19) United States
(12) Patent Application Publication
(10) Pub. No.: US 2010/0193507 A1
(43) Pub. Date: Aug. 5, 2010

(54) SPEEDCOOKING OVEN

(75) Inventors: Thomas C. Zimmer, LaGrange, KY (US); Karen M. Edberg, Louisville, KY (US); Akintoye Oladipo Oloko, Louisville, KY (US); Derek Curl, Louisville, KY (US); Michael D. Young, Louisville, KY (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/363,089

(22) Filed: Jan. 30, 2009

(51) Int. Cl. H05B 6/64

(52) U.S. Cl. 219/681

(57) ABSTRACT

An oven comprises a cooking cavity, a RF generation module, an upper heater module, a lower heater module and a convection heater module. The RF generation module is configured to deliver microwave energy into the cooking cavity. The upper heater module includes at least one of a halogen lamp and a ceramic heater. The lower heater module includes at least one of a halogen lamp and a ceramic heater. The convection heater module includes a sheath heater and a convection fan positioned to direct air over solely the sheath heater into the cooking cavity. The upper heater module and lower heater module are configured to deliver radiant energy into the cooking cavity. The convection heater module is configured to deliver thermal energy into the cooking cavity. A control is operatively connected to the RF generation module, upper heater module, lower heater module and convection heater module for selective control thereof. The control operates the oven in a plurality of modes, including a microwave mode, a convection/bake mode, and a speedcooking mode. In the speedcooking mode, the control is configured to selectively control the energization of the RF generation module, upper heating module and lower heating module concurrently with the selective energization of the convection heater module.

### BACKGROUND

The present disclosure relates generally to ovens and, more particularly, to an oven operable in one of a speedcooking, microwave, and convection/bake mode.

Ovens typically are either, for example, microwave, radiant, or thermal/convection cooking type ovens. For example, a microwave oven includes a magnetron for generating RF energy used to cook food in an oven cooking cavity. Although microwave ovens cook food more quickly than radiant or thermal/convection ovens, microwave ovens do not brown the food. Microwave ovens therefore typically are not used to cook as wide a variety of foods as radiant or thermal/convection ovens.

Radiant cooking ovens include an energy source such as lamps which generate light energy used to cook the food. Radiant ovens brown the food and generally can be used to cook a wider variety of foods than microwave ovens. Radiant ovens, however, cook many foods slower than microwave ovens.

In thermal/convection ovens, the food is cooked by the air in the cooking cavity, which is heated by a heat source. Standard thermal ovens do not have a fan to circulate the hot air in the cooking cavity. Convection ovens use the same heat source as a standard thermal oven, but add a fan and a convection heater to increase cooking efficiency by circulating the hot air around the food. Thermal/convection ovens cook the widest variety of foods. Such ovens, however, do not cook as fast as radiant or microwave ovens.

One way to achieve speedcooking in an oven is to include both microwave and radiant energy sources. The combination of microwave and radiant energy sources facilitates fast cooking of foods. In addition, and as compared to microwave only cooking, a combination of microwave and radiant energy sources can cook a wider variety of foods. While speedcooking ovens are versatile and cook food quickly, typically the speedcook performance is achieved by using the combination of microwave and radiant energy sources with no convection source. The microwave and radiant energy sources were operated by a predetermined algorithm with no form of feedback. This lack of feedback prevented the oven from compensating to unpredicted conditions.

Accordingly, the present disclosure provides a speedcooking oven which concurrently uses the combination of microwave, radiant and convection energy sources to facilitate fast cooking of foods with feedback capabilities.

### BRIEF DESCRIPTION

According to one aspect of the present disclosure, an oven comprises a cooking cavity, a RF generation module, an upper heater module, a lower heater module and a convection heater module. The RF generation module is configured to deliver microwave energy into the cooking cavity. The upper heater module includes at least one of a halogen lamp and a ceramic heater. The lower heater module includes at least one of a halogen lamp and a ceramic heater. The upper and lower heater modules are configured to deliver primarily radiant energy into the cooking cavity. The convection heater module includes a sheath heater and a convection fan positioned to direct air over solely the sheath heater into the cooking cavity. The convection heater module is configured to deliver thermal energy into the cooking cavity. A control is operatively connected to the RF generation module, upper heater module, lower heater module and convection heater module for selective control thereof. The control operates the oven in a plurality of modes, including at least one and preferably all of the following modes, a microwave mode, a convection/bake mode, and a speedcooking mode. In the speedcooking mode, the control is configured to selectively control the energization of the RF generation module, upper heating module and lower heating module concurrently with the selective energization of the convection heater module.

According to another aspect of the present disclosure, a method for operating an oven including a cooking cavity and a control comprises providing a RF generation module, an upper heater module, a lower heater module and a convection heater module. The RF generation module is configured to deliver microwave energy into the cooking cavity. The upper and lower heater modules are configured to deliver radiant energy to the cooking cavity and the convection heater module is configured to deliver thermal energy into the cooking cavity. At least one input from a user indicative of whether the oven is to operate in a microwave mode, a convection/bake mode, or a speedcooking mode is obtained. The RF generation module, upper heater module, lower heater module and convection heater module are energized in accordance with the user input.

Generally, a combination of the modules is selected to provide the desired cooking characteristics for speedcooking, microwave, and convection/bake modes. For example, in the speedcooking mode, the upper and lower heater modules and RF generation module are energized concurrently with the convection heater module. The heater modules are used to heat the outside of the food, and the RF generation module is used to heat the inside of the food. In the convection/bake mode, at least one of the upper and lower heater modules are selectively energized concurrently with the convection heater module to provide the desired cooking results. In the microwave mode, the RF generation module is energized in accordance with the user selections.

### BRIEF DESCRIPTION OF THE DRAWINGS

FIG. 1 is a front view of an oven.

FIG. 2 is a schematic illustration of the oven shown in FIG. 1.

FIG. 3 is a schematic illustration of the oven shown in FIG. 1 in speedcooking mode.

FIG. 4 is a schematic illustration of the oven shown in FIG. 1 in convection/bake mode.

FIG. 5 is a schematic illustration of the oven shown in FIG. 1 in microwave mode.

FIG. 6 is a functional block diagram of the oven shown in FIG. 1.

FIG. 7 is a functional block diagram of a control and electrical subsystem of the oven shown in FIG. 1.

FIG. 8 is a block diagram illustration of a speedcooking mode.

FIG. 9 illustrates duty cycles for the speedcooking mode illustrated in FIG. 8.

FIG. 10 is a flow chart illustrating steps for thermal compensation in the speedcooking mode.

FIG. 11 is a block diagram illustration of a convection/bake mode.

FIG. 12 illustrates duty cycles for the convection/bake mode illustrated in FIG. 11.

FIG. 13 is a block diagram illustration of a microwave mode.

FIG. 14 illustrates duty cycles for the microwave mode illustrated in FIG. 13.

### DETAILED DESCRIPTION

It should, of course, be understood that the description and drawings herein are merely illustrative and that various modifications and changes can be made in the structures disclosed without departing from the present disclosure. It will also be appreciated that the various identified components of the oven disclosed herein are merely terms of art that may vary from one manufacturer to another and should not be deemed to limit the present disclosure. Although one specific embodiment of an oven is described below, it should be understood that the present disclosure can be utilized in combination with many other such ovens and is not limited to practice with the oven described herein. For example, the oven described below is an over the range type oven. The present disclosure, however, is not limited to practice with just over the range type ovens and can be used with many other types of ovens such as countertop or built-in wall ovens.

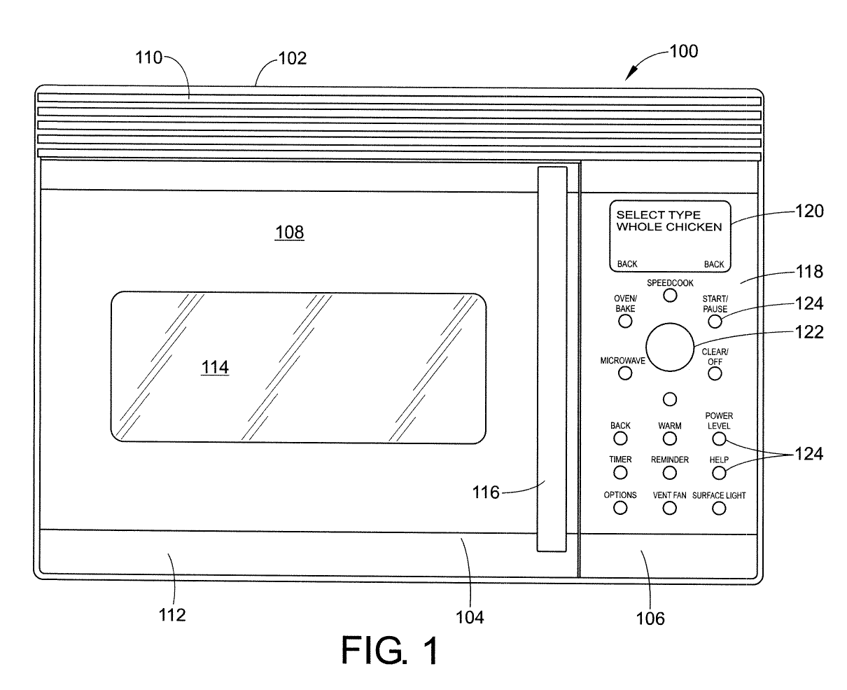

Referring now to drawings, wherein like numerals refer to like parts throughout the several views, FIG. 1 is a front view of an over the range type oven 100 in accordance with one embodiment of the present disclosure. The oven 100 includes an outer case 102, a door frame 104, and a control panel frame 106. The oven further includes a door 108 mounted within the door frame 104, a grille 110, and a bottom panel 112. A window 114 located in the door 108 is generally provided for viewing food in an oven cooking cavity, and a handle 116 is secured to door. A control panel 118 is mounted within the control panel frame.

The control panel 118 can include a display 120, a knob or dial 122, and control buttons 124. Selections are made by rotating the dial 122 clockwise or counter-clockwise and when the desired selection is displayed, pressing the dial. Alternatively, the control panel can include a plurality of buttons, one button for each desired selection. Cooking algorithms can be preprogrammed in the oven memory for many different types of foods. When a user is cooking a particular food item for which there is a preprogrammed cooking algorithm, the preprogrammed cooking algorithm is selected by, for example, rotating the dial 122 until the selected food name is displayed and then pressing the dial. Instructions and selections are displayed on the display 120.

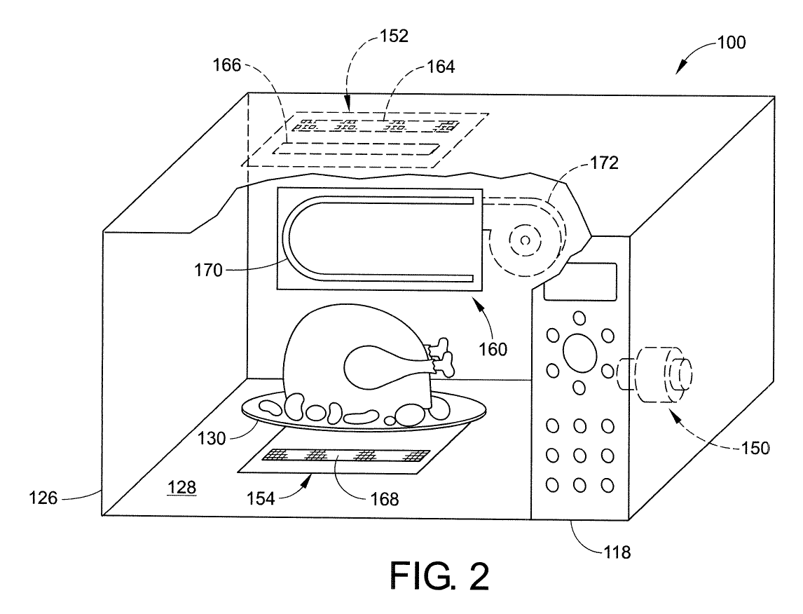

As shown in FIG. 2, the oven 100 includes a shell 126, and a cooking cavity 128 located within the shell 126. The cooking cavity 128 can be constructed using high reflectivity stainless steel. A food turntable 130 is located in the cooking cavity. The oven includes a RF generation module 150, an upper heater module 152, a lower heater module 154 and a convection heater module 160. The RF generation module is configured to deliver microwave energy into the cooking cavity 128. The upper heater module, lower heater module and convection heater module are configured to deliver radiant and thermal energy into the cooking cavity. As will be described in greater detail below, energization of the RF generation module, upper heater module, lower heater module and convection heater module are independently adjustable during operation of the oven. Cook time may also be adjusted during cooking operations.

The RF generation module includes a magnetron located on a side or top of the cooking cavity 128. The magnetron can be mounted to a magnetron mount on a surface of the cooking cavity. The magnetron can deliver about 950 W into the cooking cavity according to standard IEC (International Electrotechnical Commission) procedure. The upper heater module 152 includes at least one radiant heating element, such as at least one of a halogen lamp and a ceramic heater. As shown, the upper heater module includes both a ceramic heater 164 and a halogen cooking lamp 166. A reflector can be provided to direct energy generated from the upper heater module into the cooking cavity. The ceramic heater can be rated at 600 W and the halogen cooking lamp can also be rated at 600 W. The lower heater module 154 also includes at least one radiant heating element, such as at least one of a halogen lamp and a ceramic heater. As shown, the lower heater module includes a ceramic heater 168, which can be rated at 375 W. A reflector can be provided to direct energy generated from the lower heater module into the cooking cavity. The convection heater module 160 includes a sheath heater 170 and a convection fan 172 positioned to direct air over solely the sheath heater into the cooking cavity 128. Generally, the sheath heater and convection fan are simultaneously energized; although, this is not required. The sheath heater can be rated at 1500 W.

It should be appreciated that the heater modules and RF generation module can vary from embodiment to embodiment. For example, the upper heater module can include any combination of heaters including combinations of halogen lamps and/or ceramic heaters. Similarly, the lower heater module can include any combination of heaters including combinations of halogen lamps and/or ceramic heaters. In addition, the upper and lower heater modules can all be one type of heater. The specific ratings and number of lamps and/or heaters utilized in the upper heater module and lower heater module can vary from embodiment to embodiment. Generally, the combinations of lamps, heaters, and RF generation system are selected to provide the desired cooking characteristics for speedcooking, microwave, and convection/bake modes.

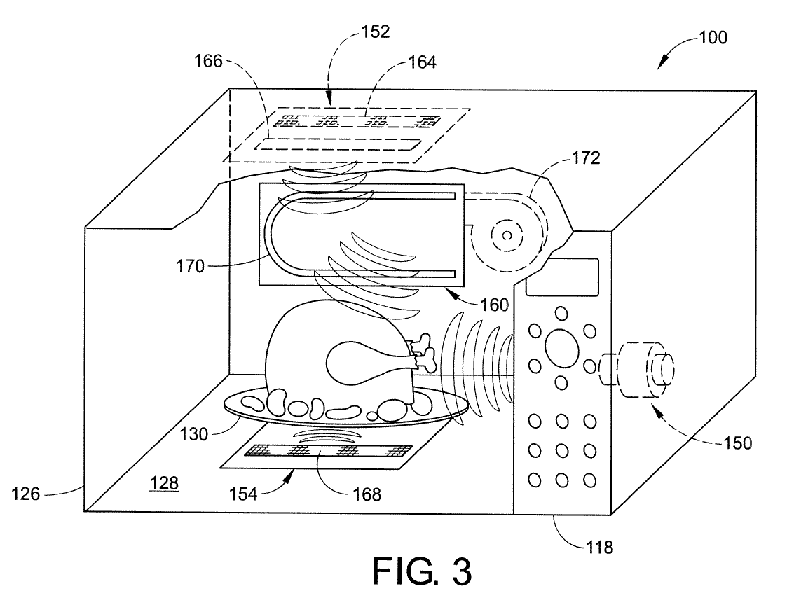

FIGS. 3, 4 and 5 schematically illustrate operation of the oven 100 in a speedcooking mode, a convection/bake mode and a microwave mode respectively. The oven 100 may, of course, operate in fewer or more operation modes than as illustrated, and the descriptions set forth below are exemplary only. In addition, operation and use of the oven 100 is not limited to the specific order of steps described below. Various steps can be performed in orders different from the exemplary order described below.

With reference to FIG. 3, generally, for the speedcooking mode, a user places food in the cooking cavity 128 on the turntable 130 and selects “Speedcook” from the control panel 118. The user selects a food type and then selects “Start”. As will be described in detail below, the RF generation module 150, upper heater module 152 and lower heater module 154 and the convection heater module 160 may be concurrently, selectively energized to heat both the outside and inside of the food in accordance with a pre-programmed cooking control algorithm for the selected food type.

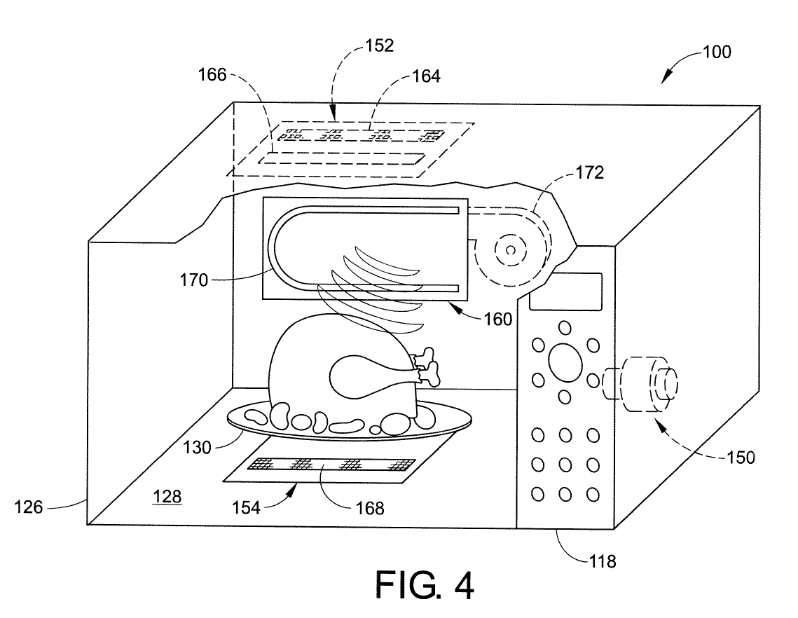

With reference to FIG. 4, generally, for the convection/bake mode, a user selects “Convection/Bake” from the keypad 118, and then selects a temperature and cook time. At least one of the upper heater module 152 and the lower heater module 154 can be energized to preheat the air in oven. The food is then placed in the cooking cavity 128 and cooking begins. During the cooking cycle, at least one of the upper heater module and lower heater module together with the convection heater module are concurrently selectively energized. As will be described in greater detail below, in the convection/bake mode, except during the pre-heat period, the convection heater module is the primary energy source, with supplemental energy from the upper or lower heater module if the selected temperature is too high for the convection module to sustain on its own, as will be further described. Energization of the upper heater module 152 and lower heater module 154 during pre-heat depends on the target temperature corresponding to the cooking temperature selected by a user and the temperature of the cooking cavity 128 upon initiation of the convection/bake mode.

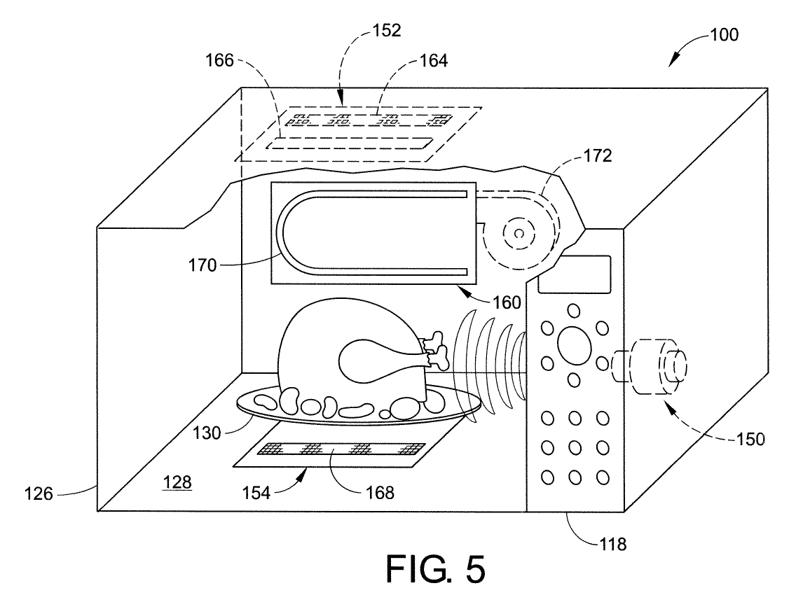

With reference to FIG. 5, generally, for the RF generation or microwave mode, the user places food in oven on the turntable 130. The user then selects “Microwave” or “Express” from the keypad 118. The user then selects “Start” from keypad 118. The magnetron is then energized in accordance with the user selections. A fan (not shown) is provided to cool the magnetron. A housing (not shown) including a chamber for defining an air flow path and having a damper therein is secured to the oven shell. The air flow facilitates the removal of moisture from the cooking cavity during microwave cooking. The damper can be opened during the microwave mode to allow moisture to escape and is closed during the speedcooking and convection/bake modes to ensure that heat remains in the cooking cavity.

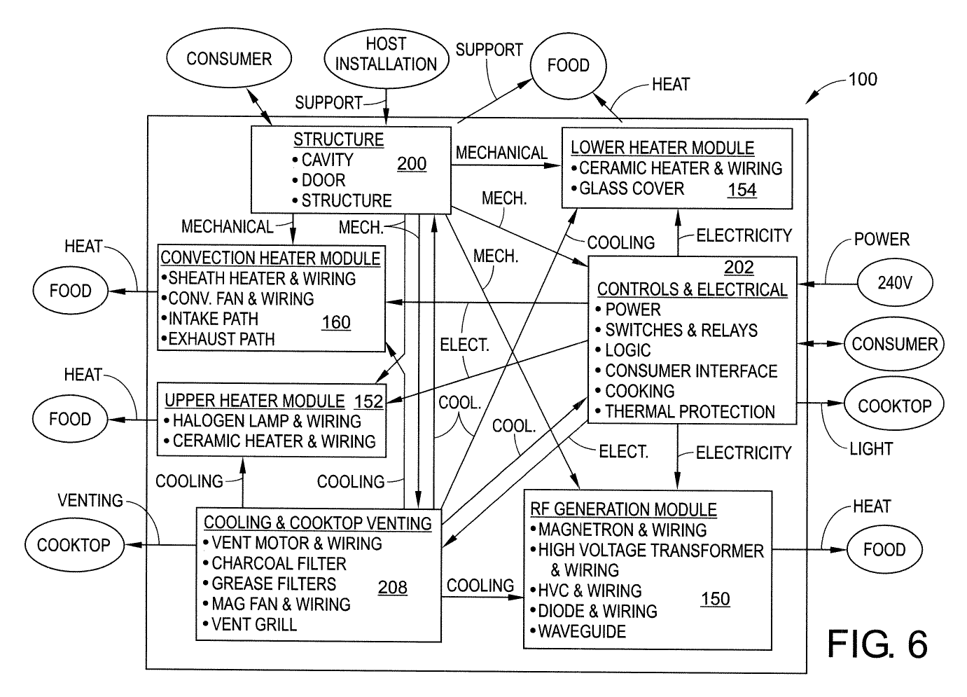

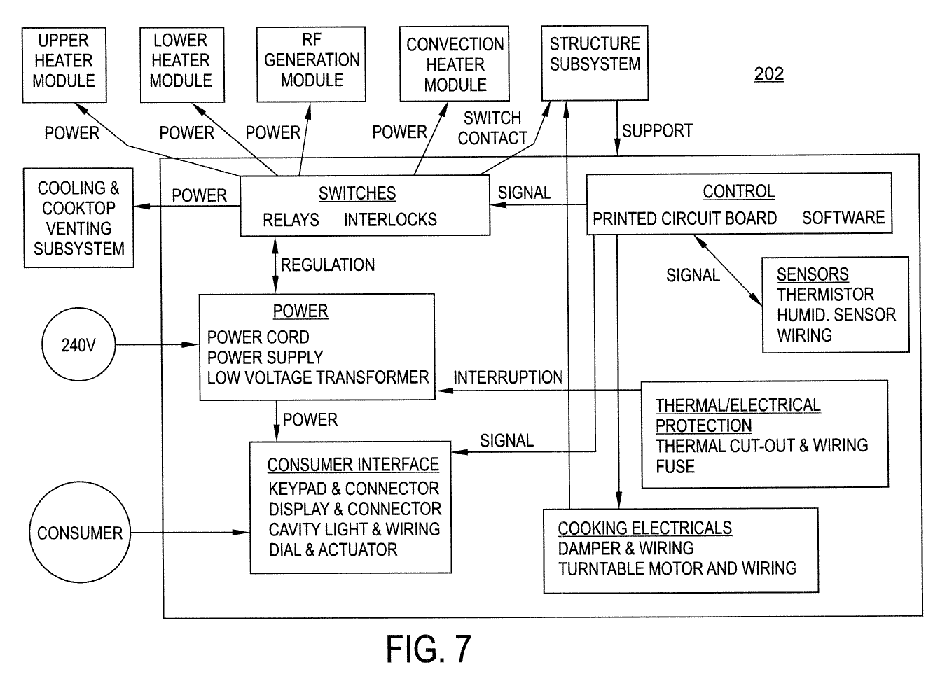

FIG. 6 is a functional block diagram of the oven 100. The oven 100 includes the RF generation module 150, the upper heater module 152, the lower heater module 154 and the convection heater module 160. The oven further includes a structural subsystem 200, a control and electrical subsystem 202 and a cooling and cook top venting subsystem 208. Exemplary features of each system are indicated in FIGS. 6 and 7.

Regarding the control and electrical subsystem, the oven is rated for operation at 240 volts. The 240 volts is required for the speedcooking mode, particularly, for the simultaneous energization of the RF generation module, upper heating module and lower heating module and the convection heater module. Thermal cut outs and a fuse (FIG. 7) also are provided to protect oven components from overheating or an over-current condition. An interlock switch can be located in the oven door 108 to prevent energization of the cooking modules unless door is closed. The control can include a micro computer on a printed circuit board which is programmed to control the energization of the cooking modules. The control and electrical subsystem can also include a door sensing switch for sensing whether the door is opened, a humidity sensor for sensing the humidity in cooking cavity and a temperature sensing device, such as a thermistor.

The temperature sensing device is located within the oven, such as the cooking cavity 128. Output from the temperature sensing device is representative of a temperature in the cooking cavity. A temperature sensed by the temperature sensing device can be affected, however, by airflow created by the cooling and cook top venting subsystem 208. Specifically, when a vent fan is on, it is possible that a signal generated by the temperature sensing device will represent a lower temperature than the actual temperature in the cooking cavity 128. As is well known, the control is configured to adjust for inaccuracies that may result from sampling the output signal of the temperature sensing device when vent fan air is flowing over, and therefore cooling, the temperature sensing device.

FIG. 7 illustrates additional functional details on the controls and electrical subsystem 202. As shown, the control is operatively connected to the RF generation module 150, the upper heater module 152, the lower heater module 154 and the convection heater module 160 for selective control thereof. The control operates the oven in the microwave mode, the convection/bake mode, and the speedcook mode.

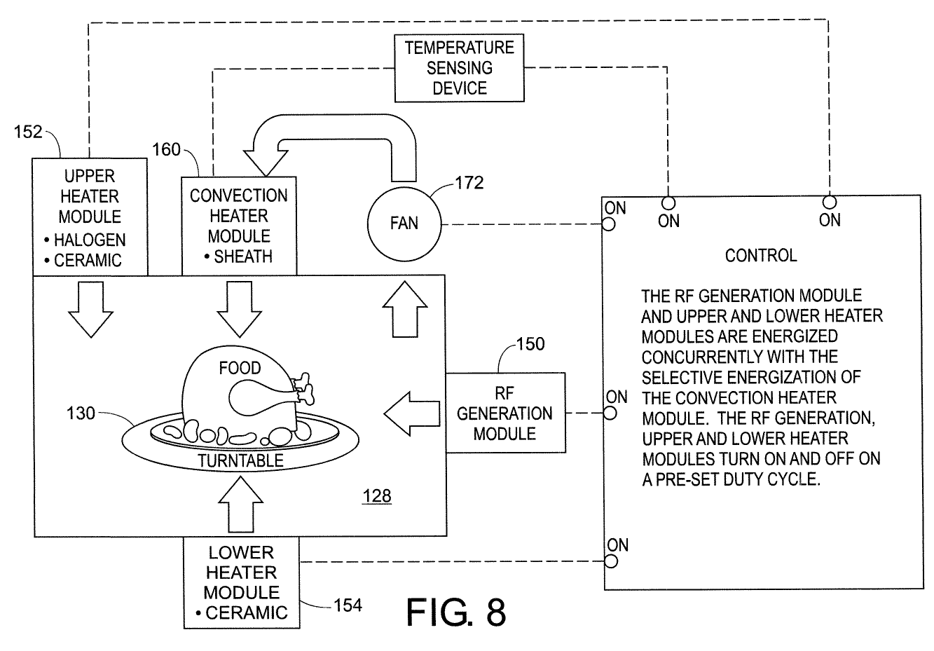

A block diagram illustration of a speedcooking mode is provided in FIG. 8. In the speedcooking mode, the RF generation module 150, upper heater module 152 and lower heater module 154 are periodically or selectively concurrently energized by the control in accordance with pre-programmed or user customized cooking algorithms determined by the parameters selected by the user when selecting the speedcooking mode. In the case where the upper heater module includes both the ceramic heater 164 and the halogen lamp 166, in the speedcooking mode, at least the halogen lamp is energized. The control is configured to cyclically energize and de-energize the RF generation module 150, upper heater module 152 and lower heater module to heat the air and radiate energy directly to the food on turntable 130. The duty cycle for each module, that is, the percent on time for the upper heater module, lower heater module and RF generation module to the control period time depends on at least one of a pre-programmed cooking algorithm and a user selected operation mode.

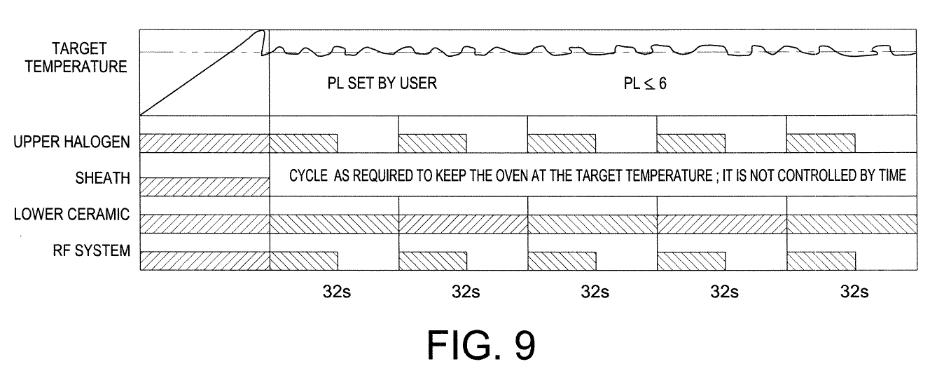

More specifically, and as shown in FIG. 9, in an exemplary embodiment, the control operates the RF generation module 150, upper heater module 152 and lower heater module 154 on a 32 second control period. The length of time each component is on during a particular control period varies depending on the power level selected. The duty cycle, or ratio of the on time, can be precisely controlled and is pre-determined by the operating parameters selected by the user. Different foods will cook best with different ratios. The oven allows control of these power levels through both pre-programmed cooking algorithms and through user-customizable manual cooking. Therefore, the RF generation module, upper heater module and lower heater module have predetermined duty cycle control settings with no feedback. In addition, and as shown in FIG. 9, during the speedcooking mode, because the oven 100 is rated for operation at 240 volts, the control can simultaneously energize the RF generation module, upper heating module and lower heating module during at least a portion of each 32 second control period concurrently with the selective energization of the convection heater module.

With continued reference to FIG. 9, in the speedcooking mode, the convection heater module 160 has associated with it, a steady state reference temperature chosen to limit the duration of temperature conditions in the oven significantly higher than the steady state reference temperature to prevent overheating of the oven. If a target or setpoint temperature established, for example, by a pre-programmed cooking algorithm, is above the steady state reference temperature, the control is configured to continuously energize the convection heater module until the target temperature is reached but then de-energize the convection heater module until the temperature of the oven drops to the reference temperature and thereafter cyclically energize the convection heater module as a function of the sensed temperature in the cooking cavity to maintain the reference temperature for the remainder a programmed cooking time If a target temperature is below the steady state reference temperature, the control is configured to energize the convection heater module at 100% duty cycle to the target temperature and then cyclically energize the convection heater module at the target temperature for the remainder a programmed cooking time. For example, and with reference to the exemplary table below, the oven can include ten power levels which can be selected by the user or established by a pre-programmed cooking algorithm for the convection heating module. Power level ten is the maximum power level. In the exemplary embodiment, the steady state reference temperature of the convection heater module is 350° F. This operating temperature corresponds to power level six (6). If power level eight (8) is selected for the convection module, which corresponds to a target temperature of 400° F., the control will energize the sheath heater 170 and convection fan 172 until the temperature in the oven reaches the target temperature of 400° F. The control will then de-energize the sheath heater 170, re-energizing cyclically in response to the sensed temperature in the cooking cavity, as necessary thereafter to maintain the sensed temperature in the oven at the steady state reference temperature of 350° F. for the remainder a programmed cooking time. If a user selects power level three (3), which corresponds to a target temperature of 320° F., the control will energize the sheath heater 170 and convection fan 172 until the oven temperature reaches the target temperature of 320° F. The control will then cycle the sheath heater at the target temperature of 320° F. for the remainder a programmed cooking time.

| Power | Target | |
|---|---|---|
| Level | Temp. | Convection Heater Module |
| 10 | 450° F. | Energize continuously until reaches Target Temperature and then cycle at 350° F. |
| | | for remainder of programmed time |
| 9 | 425° F. | Energize continuously until reaches Target Temperature and then cycle at 350° F. |
| | | for remainder of programmed time |
| 8 | 400° F. | Energize continuously until reaches Target Temperature and then cycle at 350° F. |
| | | for remainder of programmed time |
| 7 | 375° F. | Energize continuously until reaches Target Temperature and then cycle at 350° F. |
| | | for remainder of programmed time |
| 6 | 350° F. | Energize continuously until reaches Target Temperature and then cycle at 350° F. |
| | | for remainder of programmed time |
| 5 | 340° F. | Energize continuously until reaches Target Temperature and then cycle at Target |
| | | Temperature for remainder of programmed time |
| 4 | 330° F. | Energize continuously until reaches Target Temperature and then cycle at Target |
| | | Temperature for remainder of programmed time |
| 3 | 320° F. | Energize continuously until reaches Target Temperature and then cycle at target |
| | | Temperature for remainder of programmed time |
| 2 | 310° F. | Energize continuously until reaches Target Temperature and then cycle at Target |
| | | Temperature for remainder of programmed time |
| 1 | 300° F. | Energize continuously until reaches Target Temperature and then cycle at Target |
| | | Temperature for remainder of programmed time |
| 0 | | No convection element |

Further, as it relates to the RF generation module 150, upper heater module 152 and lower heater module 154, in order to prevent overheating of the oven, the control can override the user selected power levels in a customized cooking algorithm if operation at certain power levels exceeds a predetermined time period. The control adjusts the power level of each module to a first power level after a first period of time, and if the first power level is above the threshold power level for that module, the control adjusts the first power level of each module to a second lower power level after a second period of time. By way of example, the upper halogen lamp 166, lower ceramic heater 168, microwave module 150 and sheath heater 170 can be set to any combination of power levels (e.g., from 0 (not energized) to 10 (energized at 100%)). If the user sets each at power level ten (10), after a first period of time, for example 10 minutes, the halogen lamp, ceramic heater and microwave module is reduced to 70% of the set power level. If the reduced power level is still higher than the threshold power level, after a second period of time, for example 20 minutes, the halogen lamp, ceramic heater and microwave module is reduced to 50% of the set power level. As indicated previously, the sheath heater will cycle to its reference temperature, once it reaches the initially set target temperature if the selected temperature is higher than 350° F. and cycles at the selected temperature if lower than 350° F.

In addition, and for the speedcooking mode, it is possible that the speedcook operations follow a previous cooking operation. As a result, the cooking cavity may be heated rather than cool. If the cooking cavity is heated, then to achieve the desired cooking, it may be necessary to adjust the cooking algorithm to compensate for energy already present in the cooking cavity at the time speedcooking is initiated. As indicated previously, the temperature sensing device is in thermal communication with the cooking cavity 128. The temperature sensing device is coupled to the control. The control is configured to determine whether the cooking cavity is above a target temperature upon initiation of the speedcooking mode. If the cooking cavity is above the target temperature upon initiation of the speedcooking mode, the control is configured to adjust the energization of at least one of the upper heater module and the lower heater module and configured to adjust a temperature of the convection heater module.

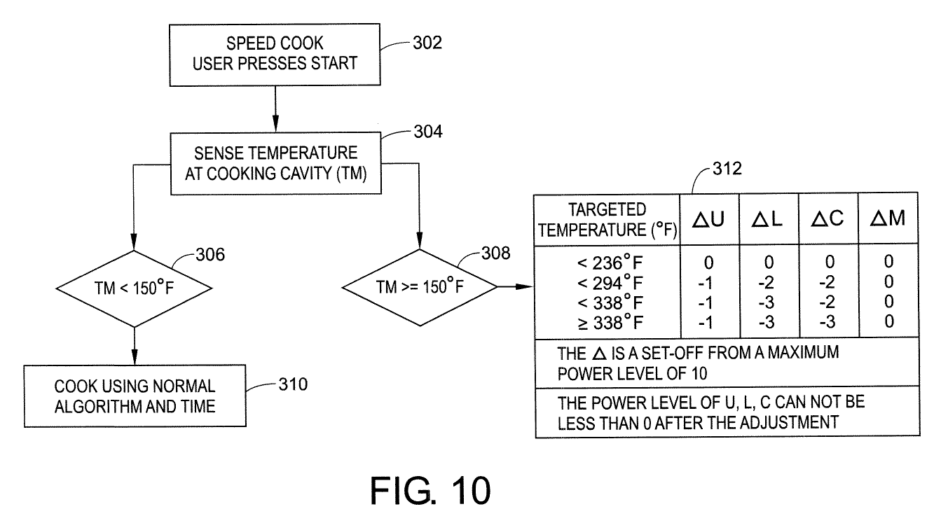

An algorithm for performing such compensation is shown in FIG. 10. Specifically, once “Speedcook” is selected (302), the cooking cavity temperature is determined (304) by the control. The control samples the temperature sensing device and determines whether the temperature sensing device sample value is less than 150° F. (306) or greater than or equal to 150° F. (308). If the temperature is less than 150° F., then the normal cooking algorithm and time are used (310), (i.e., no adjustment is made). If, however, the temperature is greater than or equal to 150° F., then a thermal compensation is performed (312). For thermal compensation, the adjustment is a set off from a maximum power level of each of the RF generation module 150, upper heater module 152, lower heater module 154 and convection heater module 160, which in the exemplary embodiment is power level 10 for each. For example, and referring to the exemplary table illustrated in FIG. 10, if the temperature is greater than or equal to 150° F., and the target temperature is less than 236° F., there is no thermal compensation. If the target temperature is greater than 236° F. and less than 294° F., the power level for the upper heater module is reduced by one to power level nine (9), the power level for the lower heater module is reduced by two to power level eight (8), and the power level for the convection heater module is reduced by two to power level (8) which in the exemplary embodiment corresponds to reduction of 10%, 10% and 20% respectively. In the exemplary embodiment, there is no thermal compensation associated with the microwave module. Generally, the thermal compensation described above prevents the temperature of the cooking cavity 128 from rising to much higher temperatures much faster than if the cooking cavity is cooled down when speed cooking is initiated. Without such thermal compensation, use of the speedcooking mode with a preheated oven could result in more energy applied to the food and the food being more cooked than planned.

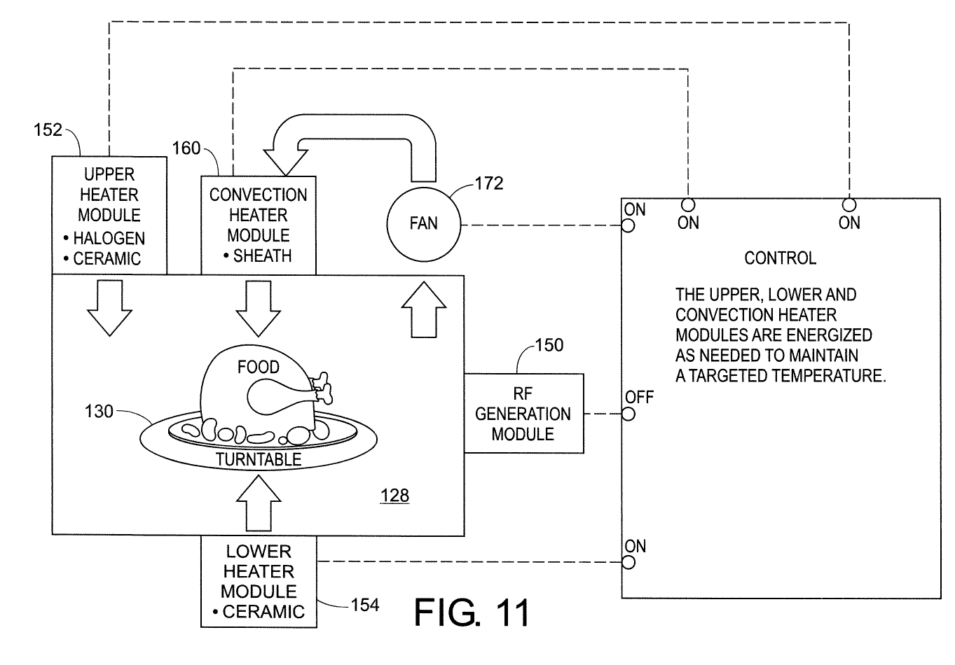

A block diagram illustration of a convection/bake mode is provided in FIG. 11. During steady state operation in the convection/bake mode, the control is configured to selectively energize the convection heater module as a function of the user selected target temperature and the temperature in the oven cavity. At least one of the upper heater module 152 and the lower heater module 154 may be concurrently duty cycle controlled to supplement the convection heater module depending on the user selected target temperature. For example, if the target temperature is greater than a predetermined convection threshold temperature, for example 400° F., the lower heater module 154 is energized at a pre-determined duty cycle which is low enough so as to not exceed the target temperature on its own. If the target temperature is less than the convection threshold temperature, then only the convection heater module is energized. In either case, the convection heater module is energized cyclically as a function of the temperature of the oven cavity to maintain the target temperature. In this mode, the cycling of the convection heater module is to whatever the selected temperature is and is not limited to the reference temperature as in the speedcooking mode.

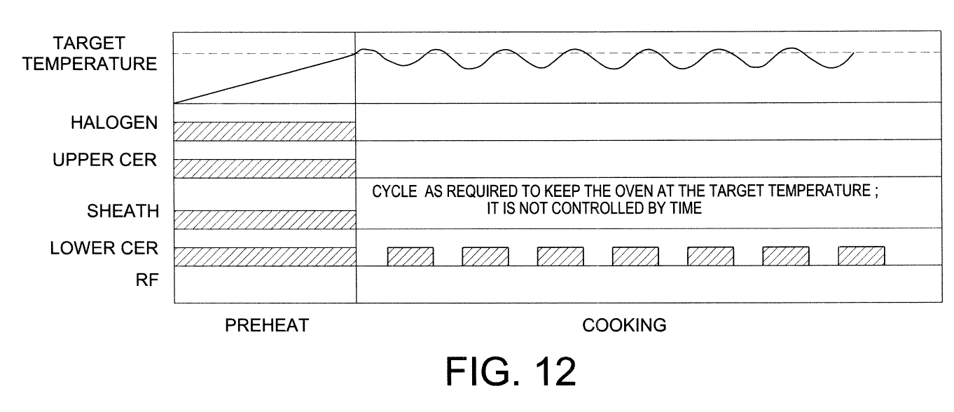

During the pre-heat period prior to first reaching the target temperature, the upper and lower heater modules and the convection heater module are operated at pre-determined power levels chosen to bring the oven to the target temperature rapidly, which could be full power, or which could be lower for lower target temperatures to prevent excessive overshoot. For example, FIG. 12 illustrates duty cycles for the convection/bake mode. During a pre-heat cycle, the sheath heater 170 and convection fan 172 are energized concurrently with the lower ceramic heater 168 and the upper ceramic heater 164 and halogen lamp 160, all at full power, that is, 100% duty cycle. Although, it should be appreciated that only one or the other of the upper and lower heater modules could be fully energized during a pre-heat cycle. Once the oven cavity temperature 127 reaches the pre-heat temperature, the control causes the lower ceramic heater of the lower heater module 154 to be energized at a pre-determined duty cycle, which may be dependent upon the selected target temperature, and de-energizes the halogen lamp and ceramic heater of the upper heater module 152. The sheath heater is cycled as a function of the sensed temperature in the cavity to maintain the target temperature. It should be appreciated that while in this example, only the lower heater module is utilized with the sheathed heater after the pre-heat period, a combination of upper and lower heater modules or only the upper heater module could be similarly utilized. The sheath heater is cyclically energized as a function of the sensed temperature of the oven cavity to maintain the target temperature in the cavity.

During the convection/bake mode, the control prevents the lower portion of the food from cooking at a faster rate than other portions of the food. Specifically, the lower heater module 154 is closer to the food than the upper heater module 152 and convection heater module 160 and therefore, unless the control is employed, the lower heater module may cause the lower portion of the food to cook faster than other portions of the food. Many control approaches can be used to achieve the desired result, i.e., even cooking of the food. For example, the lower ceramic heater can be energized for a shorter period of time than the sheath heater and upper halogen lamp. Such control facilitates maintaining the oven cavity temperature near a target temperature without over-shoot and under-shoot that may result in over or under cooking foods. Alternatively, the lower ceramic heater could be controlled to output a lower wattage than normal operation. As yet another alternative, the lower ceramic heater can be energized on every other ½ cycle, i.e., cycle skipping, to reduce the energy supplied to such heater and consequently, the energy output by the heater. Again, many alternatives are possible.

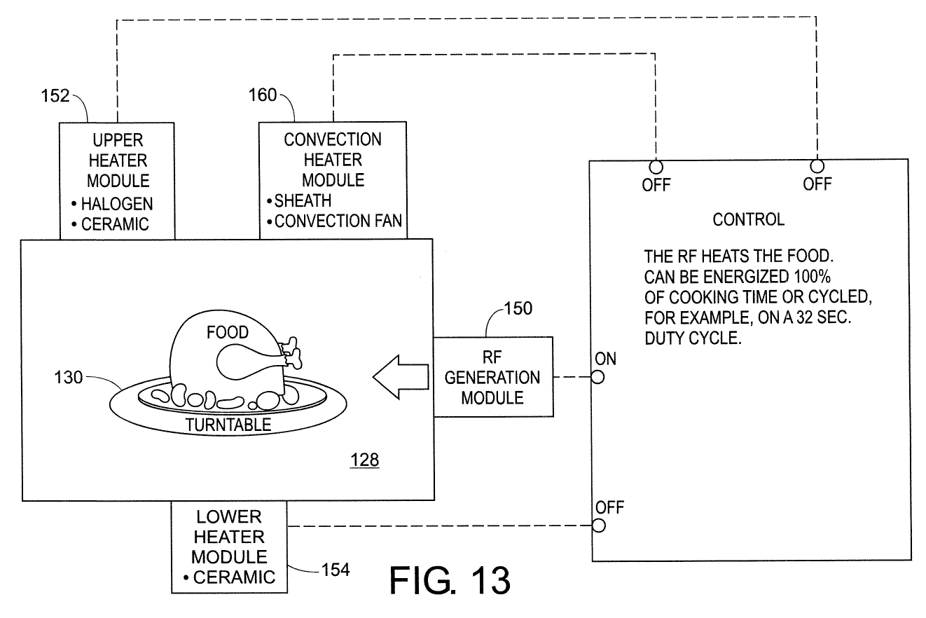

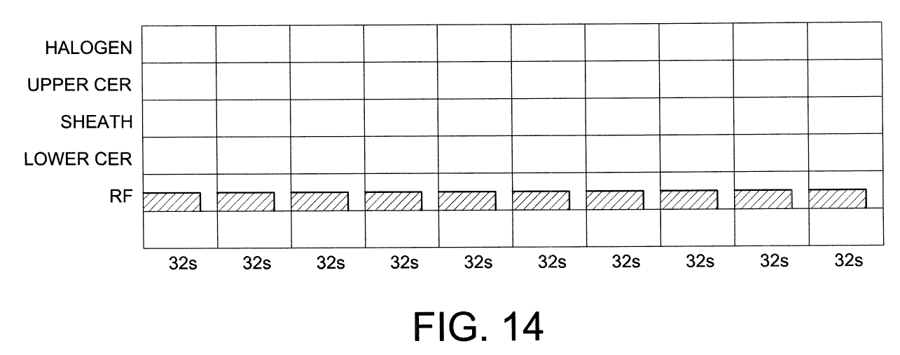

FIG. 13 is a block diagram illustration of a microwave mode. In the microwave mode, only the RF generation module 150 is on during the cooking cycle. Microwave energy from the magnetron heats the food. As shown in FIG. 14, the RF generation module can be energized for 100% of the duty cycle, or can cycle on and off for an amount of time based on the selected power level during each duty cycle.

A method for operating an oven including cooking cavity and a control comprises providing a RF generation module, an upper heater module, a lower heater module and a separate convection heater module. The RF generation module is configured to deliver microwave energy into the cooking cavity. The upper heater module, and lower heater module are configured to deliver radiant energy into the cooking cavity and the convection heater module is configured to deliver thermal energy into the cooking cavity. At least one input from a user indicative of whether the oven is to operate in a microwave mode, a convection/bake mode, or a speedcooking mode is obtained. The RF generation module, upper heater module, lower heater module and convection heater module are energized in accordance with the user input. If the oven is to operate in the microwave mode, then the RF generation module is energized. If the oven is to operate in the convection/bake mode, then at least one of the upper heater module and the lower heater module are selectively energized concurrently with the energization of the convection heater module dependent on a cooking temperature selected by a user and a temperature of the cooking cavity upon initiation of the convection/bake mode.

If the oven is to operate in the speedcooking mode, then the RF generation module, the upper heater module, and the lower module are energized concurrently with the energization of the convection heater module. The RF generation module, the upper heater module, and the lower module are cyclically energized with no feedback. A power level of each of the RF generation module, the upper heater module and the lower heater module can be automatically adjusted to avoid overheating in the oven cavity

The convection heater module is driven by feedback. Particularly, a temperature of air within the cooking cavity is measured. The convection heater module is energized when the measured temperature is below a target temperature. Specifically, a steady state reference temperature is provided for the convection heater module. If a target temperature is above the steady state reference temperature, the convection heater module is energized at 100% duty cycle to the target temperature and then cyclically energized at the reference temperature for the remainder a programmed cooking time. If a target temperature is below the reference temperature, the convection heater module is energized at 100% duty cycle to the target temperature and then cyclically energized at the target temperature for the remainder a pre-programmed cooking time. By adding the convection heater module with feedback capability, the oven is more robust to noise parameters. The feedback allows the oven to compensate to a certain degree to unpredicted conditions. Prior speedcooking ovens without temperature feedback were unable to compensate to such conditions.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An oven comprising:
a cooking cavity;
a RF generation module configured to deliver microwave energy into said cooking cavity;
an upper heater module including at least one of a halogen lamp and a ceramic heater;
a lower heater module including at least one of a halogen lamp and a ceramic heater;
a convection heater module including a sheath heater and a convection fan positioned to direct air over solely said sheath heater into said cooking cavity, wherein said upper heater module and said lower heater module are configured to deliver radiant energy into said cooking cavity and said convection heater module is configured to deliver thermal energy into said cooking cavity; and
a control operatively connected to said RF generation module, said upper heater module, said lower heater module and said convection heater module for selective control thereof,
wherein said control operates said oven in a plurality of modes, including a speedcooking mode,
wherein in said speedcooking mode, said control is configured to selectively control the energization of said RF generation module, said upper heating module and said lower heating module concurrently with the selective energization of said convection heater module.

2. The oven of claim 1, further comprising a temperature sensor for sensing the temperature in said cooking cavity and wherein in said speedcooking mode, said RF generation module, said upper heater module and said lower heater module operate at predetermined duty cycles, and said convection heater module is cyclically energized as a function of the sensed temperature in said cooking cavity.

3. The oven of claim 2, wherein in said speedcooking mode, said control is configured to cyclically energize and de-energize said upper heater module, said lower heater module and said RF generation module to radiate energy directly to food within said cooking cavity, said pre-determined duty cycle for each module depends on at least one of a pre-programmed cooking algorithm and a user selected operation mode.

4. The oven of claim 3, wherein in said speedcooking mode, said control is configured to concurrently energize said upper heater module, said lower heater module and said RF generation module.

5. The oven of claim 2, wherein in said speedcooking mode, said control operates said upper heater module, said lower heater module and said RF generation module at predetermined duty cycles, with 32 second duty cycle period, throughout a selected cooking cycle.

6. The oven of claim 1, wherein in said speedcooking mode, said sheath heater and said convection fan are simultaneously energized by said control.

7. The oven of claim 1, wherein said upper heater module includes both a halogen lamp and a ceramic heater, wherein in said speedcook mode, at least said halogen lamp of said upper heater module is selectively energized.

8. The oven of claim 1, wherein said plurality of modes includes a convection/bake mode, and wherein in said convection/bake mode said control is configured to selectively energize said convection heater module as a function of a user selected target temperature and a temperature of said cooking cavity upon initiation of said convection/bake mode, and selectively energize at least one of said upper heater module and said lower heater module concurrently with the energization of said convection heater module to supplement said convection heater module depending on said target temperature.

9. The oven of claim 1, wherein in said speedcooking mode, said convection heater module includes a reference temperature, wherein if a target temperature is above said reference temperature, said control is configured to fully energize said convection heater module until reaching the target temperature and then cyclically energize said convection heater module to maintain said reference temperature for the remainder a programmed cooking time.

10. The oven of claim 9, wherein if a target temperature is below said reference temperature, said control is configured to fully energize said convection heater module until reaching the target temperature and then cyclically energize said convection heater module to maintain said target temperature for the remainder a programmed cooking time.

11. The oven of claim 1, further comprising a temperature sensing device in thermal communication with said cooking cavity, said temperature sensing device coupled to said control, wherein said control is configured to determine whether a temperature of said cooking cavity is above a target temperature upon initiation of said speedcooking mode, wherein if said cooking cavity is above said target temperature upon initiation of the speedcooking mode, said control is configured to adjust the energization of at least one of said upper heater module and said lower heater module and said convection heater module.

12. A method for operating an oven including cooking cavity and a control said method comprising:
providing a RF generation module configured to deliver microwave energy into the cooking cavity;
providing an upper heater module, a lower heater module, and a separate convection heater module, wherein said upper heater module and said lower heater module are configured to deliver radiant energy into the cooking cavity and said convection heater module is configured to deliver thermal energy into the cooking cavity;
obtaining at least one input from a user indicative of whether the oven is to operate in a microwave mode, a convection/bake mode, or a speedcooking mode; and
energizing said RF generation module, said upper heater module, said lower heater module and said convection heater module in accordance with the user input.

13. The method of claim 12, wherein if the oven is to operate in the microwave mode, then the RF generation module is energized, and
wherein if the oven is to operate in the convection/bake mode, then at least one of said upper heater module and said lower heater module are selectively energized concurrently with the energization of said convection heater module, the energization of said convection heater module being dependent on a cooking temperature selected by a user and a temperature of said cooking cavity upon initiation of said convection/bake mode.

14. A method of claim 12, wherein if the oven is to operate in the speedcooking mode, then said RF generation module, said upper heater module, and said lower module are energized concurrently with the energization of said convection heater module.

15. The method of claim 14, further comprising cyclically energizing said RF generation module, said upper heater module, and said lower module with no feedback.

16. The method of claim 14, further comprising:
measuring a temperature of air within the cooking cavity, and
energizing said convection heater module when the measured temperature is below a target temperature.

17. The method of claim 16, further including providing a reference temperature for said convection heater module, wherein if a target temperature is above said reference temperature, said convection heater module is fully energized until reaching the target temperature and then cyclically energized to maintain said reference temperature for the remainder a programmed cooking time.

18. The method of claim 17, wherein if a target temperature is below said reference temperature, said convection heater module is fully energized until reaching the target temperature and then cyclically energized to maintain the target temperature for the remainder a pre-programmed cooking time.

19. The method of claim 15, further including selectively adjusting a power level of each of said RF generation module, said upper heater module and said lower heater module when the power level of each of said RF generation module, said upper heater module and said lower heater module is above a threshold power level for that heater module.

20. The method of claim 19, further including adjusting the power level of each of said RF generation module, said upper heater module and said lower heater module to a first power level after a first period of time, and
if said first power level is above the threshold power level for that heater module, adjusting the first power level of each of said RF generation module, said upper heater module and said lower heater module to a second lower power level after a second period of time.
